(19) United States
(12) Patent Application Publication
(10) Pub. No.: US 2024/0425331 A1
(43) Pub. Date: Dec. 26, 2024

(54) Ejector and a Rope for a Forestry Winch

(71) Applicant: Bernward Welschof, Grossostheim (DE)

(72) Inventors: Michael Willenbücher, Oberzent (DE); Claus Hofmann, Haibach (DE); Bernward Welschof, Grossostheim (DE)

(21) Appl. No.: 18/746,372

(22) Filed: Jun. 18, 2024

(30) Foreign Application Priority Data
Jun. 22, 2023 (DE) 10 2023 116 461.9
Jul. 12, 2023 (DE) 10 2023 118 405.9

(51) Int. Cl. B66D 1/38; B66D 1/50

(52) U.S. Cl. CPC B66D 1/38; B66D 1/50

(57) ABSTRACT

An arrangement includes an ejector and a rope, in particular steel rope or synthetic rope, for a forestry winch. The ejector has a rotational ejector roller over which the rope is guided and deflected, and at least one driven rotational pressure roller driven by a drive motor. The pressure roller, by a pressure force, presses the rope guided over the ejector roller onto the ejector roller, and a tangential force occurs between the driven pressure roller and the rope. The pressure roller is located on a cantilever arm so that the pressure roller can rotate around a pressure roller axis of rotation. The cantilever arm is mounted so that it can rotate around a cantilever arm axis of rotation. The cantilever arm axis of rotation is located in the vertical direction above a line of application of the tangential force.

### CROSS-REFERENCE TO RELATED APPLICATIONS

This application claims priority to German Patent Application No. 10 2023 116 461.9 filed Jun. 22, 2023 and German Patent Application No. 10 2023 118 405.9 filed Jul. 12, 2023, the disclosures of which are hereby incorporated by reference in their entireties.

### BACKGROUND OF THE INVENTION

### Field of the Invention

This invention relates to an arrangement comprising an ejector and a rope, in particular steel rope or synthetic rope, for a forestry winch, wherein the ejector has a rotational ejector roller over which the rope is guided and deflected, and at least one driven rotational pressure roller, in particular a pressure roller driven by means of a drive motor, wherein the pressure roller, by means of a pressure force, presses the rope guided over the ejector roller onto the ejector roller, and a tangential force occurs between the driven pressure roller and the rope, wherein the pressure roller is located on a cantilever arm so that it can rotate around a pressure roller axis of rotation, and wherein the cantilever arm is mounted so that it can rotate around a cantilever arm axis of rotation.

### Description of Related Art

Known forestry winches include models with a steel rope and a synthetic rope.

On forestry winches with a steel rope, it is known that a rope located on a rope drum of the forestry winch can be guided over an ejector roller of an ejector, wherein the ejector roller is actively driven by means of a drive motor, and the rope is pressed against the ejector roller by means of a pressure roller. With the ejector roller driven by the drive motor, as the steel rope is being unspooled from the rope drum and as the steel rope is being taken up on the rope drum, a desired axial force and thus a rope tension can be applied to the steel rope, which makes possible a safe and correct unspooling of the steel rope from the rope drum when the rope is being unspooled as well as a safe and correct take-up of the steel rope on the rope drum when the rope is being taken up. With the axial force and thus the rope tension applied to the steel rope by the driven ejector roller, less effort is also required on the part of an operator who must pull the steel rope over a significant distance of up to 100 m as the steel rope is being unspooled from the rope drum. One disadvantage of forestry winches with a steel rope, however, is the heavy weight of the steel rope, which requires a great deal of effort on the part of the operator to carry the steel rope as the steel rope is being unspooled.

Forestry winches with a synthetic rope are also known. A synthetic rope is a textile rope with a flexible synthetic fiber structure that does not retain its shape, and has the advantage over a steel rope of lower weight. Furthermore, smaller bending radii become possible when a synthetic rope is being taken up under no load onto the rope drum of the forestry winch. A significant advantage of forestry winches with a synthetic rope over forestry winches with a steel rope lies in the significantly lower weight of the synthetic rope, as a result of which, when the synthetic rope is being unspooled, significantly less effort is required on the part of the operator to carry the synthetic rope.

However, known ejectors for forestry winches with a steel rope are not suitable for use on a forestry winch with a synthetic rope. Known ejectors for forestry winches with a steel rope are designed to handle a round steel rope that experiences little or no deformation and are unsuitable for use with a flexible, highly deformable synthetic rope that is sensitive to sharp edges.

WO 2009/072992 A2 discloses an ejector for a forestry winch with a synthetic rope.

### SUMMARY OF THE INVENTION

The object of the present invention is to make available an ejector for a forestry winch that is optimized for use with a synthetic rope, can apply appropriate forces to a synthetic rope and can eject the synthetic rope in a way that protects it against damage.

The invention accomplishes this object in that the cantilever arm axis of rotation is oriented in the vertical direction above a line of application of the tangential force.

According to the invention, therefore, the cantilever arm axis of rotation around which the cantilever arm is rotationally mounted is oriented in the vertical direction above the line of application of the tangential force that occurs between the driven pressure roller and the rope during operation of the ejector. With an arrangement and position of this type of the cantilever arm axis of rotation, the tangential force around the cantilever arm axis of rotation generates a torque with which the pressure roller, in addition to the pressure force, presses the rope onto the ejector roller, so that with the tangential force, a self-reinforcement of the pressing action of the pressure roller is achieved. With the arrangement and position of the cantilever arm axis of rotation, high forces can be transmitted to the synthetic rope and the synthetic rope can be ejected in a correct manner that protects the rope against damage.

According to one advantageous configuration of the invention, the pressure roller has a rubberized outside circumferential surface, by means of which the pressure roller is in contact with the rope, wherein the Shore A hardness of the rubberized outside circumferential surface is in the range of 40 to 80, in particular in the range of 55 to 75.

A Shore A hardness of the rubberized outside circumferential surface of the pressure roller in the range of 40 to 80, in particular in the range of 55 to 75, has the advantage that, on one hand, an effective and strong transmission of force to the synthetic rope is achieved with low flexing forces, as a result of which high forces can be transmitted to the synthetic rope and the synthetic rope can be ejected in a correct fashion that protects the rope against damage, and, on the other hand, the rubberized outside circumferential surface of the pressure roller has sufficient elasticity and high strength.

The ejector roller can in this case be a solid rubber roller, or alternatively can be in the form of a steel wheel onto which the rubberized outside circumferential surface is vulcanized.

According to one advantageous configuration of the invention, the line of application of the pressure force is separated from the cantilever arm axis of rotation by a first lever arm and the line of application of the tangential force is separated from the cantilever arm axis of rotation by a second lever arm, whereby the ratio of the second lever arm to the first lever arm is in the range of 0.4 to 1.8, in particular in the range of 0.6 to 1.2, preferably in particular in the range of 0.8 to 1.1.

With a ratio of the lever arms of this type, on one hand, a sufficiently high self-reinforcement of the pressing action of the pressure roller is achieved to transmit high forces to the synthetic rope so that the synthetic rope can be ejected in a protective and orderly manner, and, on the other hand, an excessive self-reinforcement of the pressing action of the pressure roller is avoided, which would result in high deformations of the rubberized outside circumferential surface of the pressure roller, and could lead to damage or failure of the rubberized outside circumferential surface of the pressure roller.

According to one advantageous configuration of the invention, the driven pressure roller and the ejector roller are rotationally coupled, and between the driven pressure roller and the ejector roller an entrainment is created for the drive of the ejector roller by the pressure roller, wherein the pressure roller has at least one rubberized end surface, by means of which the pressure roller is in contact with the ejector roller, wherein the Shore A hardness of the rubberized end surface is in the range of 40 to 80, in particular in the range of 55 to 75.

In particular in one embodiment of the invention in which the rotational pressure roller is actively driven by means of a drive motor, a condition can be achieved in which the ejector roller is not rotated and therefore driven by means of the synthetic rope, but is driven and rotated by means of the entrainment by the pressure roller which is actively driven by the drive motor, as a result of which a secure drive of the ejector roller can be achieved that results in low wear on the synthetic rope and the ejector roller. With an entrainment, in one particularly simple embodiment, an entrainment of the ejector roller and thus a drive of the ejector roller by the actively driven pressure roller can be achieved. For this purpose, the pressure roller preferably has at least one rubberized end surface, by means of which the pressure roller is in contact with the ejector roller, wherein the Shore A hardness of the rubberized end surface is in the range of 40 to 80, in particular in the range of 55 to 75. With a rubberized end surface, good force transmission levels can be achieved for an entrainment of the pressure roller driven by means of the drive motor to the ejector roller driven by the pressure roller. A Shore A hardness of the rubberized end surface of the pressure roller in the range of 40 to 80, in particular in the range of 55 to 75, has the advantage that, on one hand, a good and high transmission of force to the ejector roller to be driven is achieved with low slippage forces, as a result of which the ejector roller can be securely rotated and driven by the driven pressure roller, and, on the other hand, the rubberized end surface of the pressure roller has sufficient elasticity and high strength.

According to one advantageous configuration of the invention, for the generation of the pressure force to be applied to the pressure roller, a spring device comprising at least one tension spring is provided, wherein the spring device is biased so that a pressure force in the range between 50 N and 500 N, in particular in the range between 60 N to 400 N, particularly preferably between 70 N and 300 N, is generated on the rope.

With a bias of the spring device sufficient to generate a pressure force on the rope in the range between 50 N and 500 N, in particular in the range between 60 N and 400, particularly preferably between 70 N and 300 N, a sufficient basic pressing of the pressure roller on the rope guided by means of the ejector roller can be achieved. With a rope in the form of a synthetic rope, the free ends of the rope are bent by 180° on the rope ends and threaded into the synthetic rope. As a result, on the areas of the rope ends the synthetic rope has twice the diameter over a length of approximately 1 to 2 m. A spring device in the form of a tension spring, in contrast to a spring device in the form of a compression spring, is not sensitive to these diameter tolerances on the rope ends of a synthetic rope if the synthetic rope with twice the diameter gets between the ejector roller and the pressure roller.

According to one advantageous configuration of the invention, the spring rate of the spring device is in the range between 3 N/mm and 10 N/mm, preferably in the range between 4 N/mm and 8 N/mm, particularly preferably in the range between 5 N/mm and 7 N/mm.

With a spring rate of the spring device of this type, in particular when the spring device is in the form of a tension spring, a secure deflection of the pressure roller can be achieved to compensate for the diameter tolerances of a synthetic rope on the end of the rope if the synthetic rope with twice the diameter gets between the ejector roller and the pressure roller.

According to one advantageous configuration of the invention, a limiting device is provided that limits the spring travel of the spring device. With a limiting device of this type, it becomes possible in a simple manner to prevent excessive application forces and thus pressure forces from being exerted on the synthetic rope, which could damage the synthetic rope, for example in the event of an improper repair or as the result of an operating error.

According to one advantageous configuration of the invention, the spring device is fastened to a regulating screw, wherein the regulating screw is in connection by means of a regulating nut with an abutment and the regulating screw is provided with a screw head, wherein the screw head is designed so that the screw head can interact with the abutment to limit the spring travel of the spring device. As a result of the contact of the screw head of the regulating screw against the abutment, the spring travel and therefore the maximum spring force of the spring device can be limited, so that it becomes possible in a simple manner to prevent excessive application forces and thus pressure forces from being exerted on the synthetic rope.

According to one advantageous embodiment of the invention, the ejector roller has a locator groove for the synthetic rope, wherein the locator groove has a groove base, in particular a flat or domed groove base, on which the synthetic rope lies, and two lateral groove flanks, wherein the pressure roller is configured so that it protrudes into the locator groove of the ejector roller and the pressure roller is designed so that it protrudes into the locator groove so that the rope is pressed against the groove base by the rubberized outside circumferential surface of the pressure roller and/or so that the rubberized end surfaces of the pressure roller are in contact against the groove flanks of the ejector roller. The contour of the ejector roller formed by the locator groove and the contour of the pressure roller that is formed by the outside circumferential surface and the end surfaces of the pressure roller that protrudes into the locator groove are therefore configured so that an increase of the force transmission to the synthetic rope, an avoidance of rope wear of the synthetic rope and an adaptation of the shape to the non-dimensionally stable synthetic rope is achieved, as a result of which the flattening of the synthetic rope under load, which is a consequence of the design, is taken into account. Contours of this type and a shaping of the ejector roller and of the pressure roller of this type also make possible a simple drive of the ejector roller by the pressure roller which is actively driven by the drive motor by an entrainment via the flanks formed between the end surfaces of the pressure roller and the groove flanks of the ejector roller, so that the ejector roller is not set in motion only by the synthetic rope but directly by the pressure roller.

According to one advantageous configuration of the invention, the axis of rotation of the cantilever arm has play around a vertical axis. As a result, it becomes possible in a simple manner for the pressure roller, when it projects into the locator groove of the ejector roller, to be adjusted in the lateral direction, and therefore when the pressure roller protrudes into the locator groove, the ejector roller can be oriented relative to the locator groove of the ejector roller to compensate for any tolerances that may be present.

In one advantageous configuration of the invention, the rubberized outside circumferential surface of the pressure roller has a width in the range of a factor of 0.5 to a factor of 2.5 of the rope diameter. With a width in this range of the rubberized outside circumferential surface of the pressure roller, on one hand, a secure transmission of force in the form of the transmission of force via the flanks becomes possible to drive the ejector roller by the pressure roller driven by means of the drive motor, and, on the other hand, it also becomes possible to limit the surface pressure on the synthetic rope to avoid damage to the synthetic rope.

In one advantageous configuration of the invention, the ratio of a groove opening width of the locator groove of the ejector roller to the maximum width of the rubberized outside circumferential surface of the pressure roller is in the range between 0.6 and 2.0, in particular in the range between 0.7 and 1.5. With such a ratio of the groove opening width of the locator groove of the ejector roller to the maximum width of the rubberized outside circumferential surface of the pressure roller, when the pressure roller protrudes into the locator groove of the ejector roller, there is a secure transmission of force in the form of the transmission of force via the flanks to drive the ejector roller by the pressure roller driven by means of the drive motor, and a sufficient force transmission to the synthetic rope, and simultaneously it is ensured that the synthetic rope cannot be pulled out of the locator groove through any remaining gap between the locator groove and the pressure roller if the rope is ejected diagonally.

According to one advantageous configuration of the invention, the driven pressure roller is located on the ejector roller so that there is an angle between 0° and 40°, in particular between 10° and 35°, particularly preferably between 15° and 30° between a force application point of the tangential force and an ejection point of the rope from the ejector roller. As a result, there is a short ejection path of the rope between the force application point of the tangential force and the ejection point of the rope from the ejector roller. In contrast to a steel rope, a rope in the form of a synthetic rope can be pushed by the ejector only over a short distance on account of the high flexibility of the synthetic rope. With a positioning of the pressure roller on the ejector roller so that there is an angle between 0° and 40°, in particular between 10° and 35°, particularly preferably between 15° and 30°, between a force application point of the tangential force and an ejection point of the rope from the ejector roller, a secure ejection of the synthetic rope can be achieved when the rope is a synthetic rope.

According to one advantageous development of the invention, the ejector has a rope ejector opening for the rope that is bordered laterally by two side plates, between which the synthetic rope is guided, whereby the side plates have rounded inside edges in the form of rounded rope runout edges and the side plates are each made of a non-metallic material, in particular a synthetic material such as Duroplast, for example. As a result, the ejector has a rope ejector opening suitable for use with a synthetic rope. With side plates that have rounded inside edges, for example in the shape of segments of a circle, as the rope runs out, sharp edges on the surfaces of the side plates that come into contact with the synthetic rope during a lateral runout or lateral run-in of the rope can be eliminated, as a result of which wear on the synthetic rope can be prevented during a lateral runout, as well as the lateral run-in of the synthetic rope. The manufacture of the side plates from a non-metallic material such as a synthetic material, for example, brings about additional advantages, because any minor damage that may occur on the side plates, such as scratches or scuff marks, for example, as a result of branches being pulled in, can be repaired by the user on the spot during use in a forested area.

The invention further relates to a forestry winch that has a rope drum driven by a drive motor and an arrangement according to the invention, wherein the rope is guided from the rope drum to the ejector roller and guided over the ejector roller. With the ejector according to the invention, a forestry winch is made available which can be used as a felling and/or pulling winch and which is provided with a synthetic rope, wherein the forestry winch has a user-friendly rope ejection requiring little effort on the part of the operator to pull the synthetic cable during the unspooling of the synthetic rope and little effort on the part of the operator to carry the synthetic rope as well as a good spooling quality of the synthetic rope on the rope drum.

According to one advantageous configuration of the invention, a rope stopper is located on the rope, and located in the vicinity of the rope drum is a rope stopper catch which is designed to interact with the rope stopper. During the ejection of the rope, it is known that the rope drum and the ejector roller can be driven in the unspooling direction. When the rope is in the form of a synthetic rope, during the ejection of the rope an over-rotation of the rope drum can occur when the rope reaches its end, in which case the rope drum driven in the unspooling direction rewinds the synthetic rope onto the rope drum because a synthetic rope, on account of its high flexibility, does not have any internal resistance that prevents the over-rotation of the rope drum. With a rope stopper catch located in the vicinity of the rope drum that cooperates with the rope stopper on the end of the rope, it becomes possible in a simple manner during the ejection of the rope, when the rope reaches its end, to prevent the over-rotation of the rope drum and an accidental spooling of the rope back onto the rope drum.

According to one advantageous configuration of the invention, the rope stopper is in the form of a ferrule or a clamp component or a screw component attached to the rope. With a ferrule or clamp component or screw component fastened to the rope, it becomes possible in a simple manner to provide the rope with a rope stopper.

According to one advantageous configuration of the invention, the rope stopper catch has a locator groove, in particular a V-shaped locator groove, into which the rope stopper can be inserted. The rope stopper catch therefore has a locator groove and is fork-shaped, as a result of which the rope stopper on the rope can easily and securely come into contact with the rope stopper catch to prevent an over-rotation of the rope drum when the rope reaches its end during the ejection of the rope.

According to one advantageous configuration of the invention, in a contact position, the rope stopper located on the rope is in contact by means of a lower end surface with an upper side of the rope stopper catch. As a result, the rope stopper on the rope can easily and securely come into contact with the rope stopper catch and an over-rotation of the rope drum during the ejection of the rope can be prevented when the rope comes to an end.

### BRIEF DESCRIPTION OF THE DRAWINGS

The terms Fig., Figs., Figure, and Figures are used interchangeably in the specification to refer to the corresponding figures in the drawings.

Additional advantages and details of the invention are described in greater detail below with reference to the exemplary embodiments illustrated in the accompanying schematic figures, in which

FIG. 1 is a schematic illustration of a forestry winch according to the invention,

FIG. 2 is a schematic side view of an ejector arrangement in FIG. 1,

FIG. 3 is a view according to FIG. 2 indicating the leverages and forces,

FIG. 4 is a front elevation along arrow Y in FIG. 2,

FIG. 5 is a schematic illustration of the spring device pressing on the pressure roller,

FIG. 6a, 6b are side views of the rope drum on the rope end during the unspooling of the rope,

FIG. 7 is a detail of FIG. 6 in an overhead view,

FIG. 8 is a side view of a constructive realization of an ejector arrangement,

FIG. 9 is a front elevation along arrow X in FIG. 8.

### DESCRIPTION OF THE INVENTION

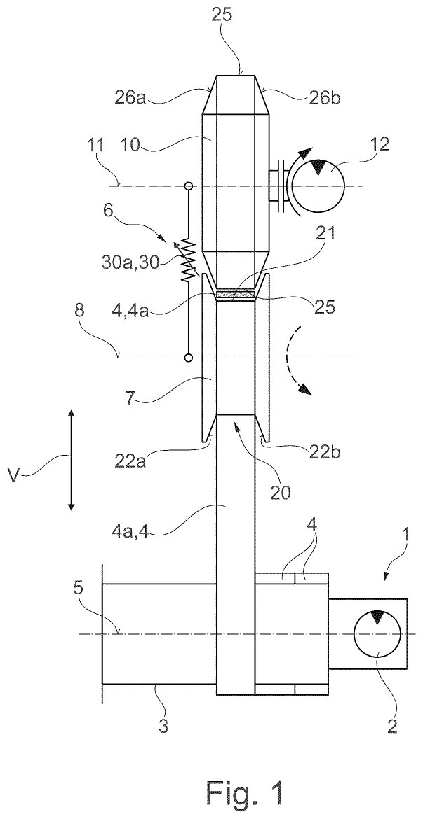

FIG. 1 is a schematic illustration of a forestry winch 1 according to the invention. FIG. 1 is a front elevation of the forestry winch 1 according to the invention.

The forestry winch 1 has a rope drum 3 which is driven by a drive motor 2 and on which, in the illustrated embodiment, a rope 4 in the form of a synthetic rope 4a is spooled. The rope drum 3 can rotate around an axis of rotation 5 and is driven by the drive motor 2. The drive motor 2 can be a hydraulic motor or an electric motor, for example.

The forestry winch 1 further has an ejector arrangement, which comprises an ejector 6 and the rope 4 in the form of a synthetic rope 4a.

The ejector 6 has an ejector roller 7 which rotates around an axis of rotation 8.

The synthetic rope 4a is guided from the rope drum 3 in the vertical direction V to the ejector roller 7, guided over the ejector roller 7 and deflected on the ejector roller 7 so that the rope 4a is guided away from the ejector roller 7 in the horizontal direction.

The ejector 6 also has at least one pressure roller 10 which rotates around an axis of rotation 11 and by means of which the synthetic rope 4a is pressed against the ejector roller 7.

The pressure roller 10 is actively driven by a drive motor 12. The drive motor 12 can be a hydraulic motor or an electric motor, for example.

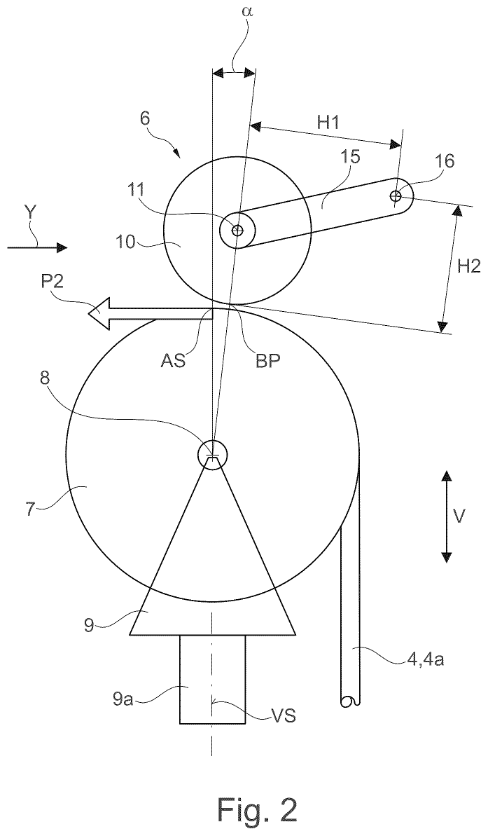

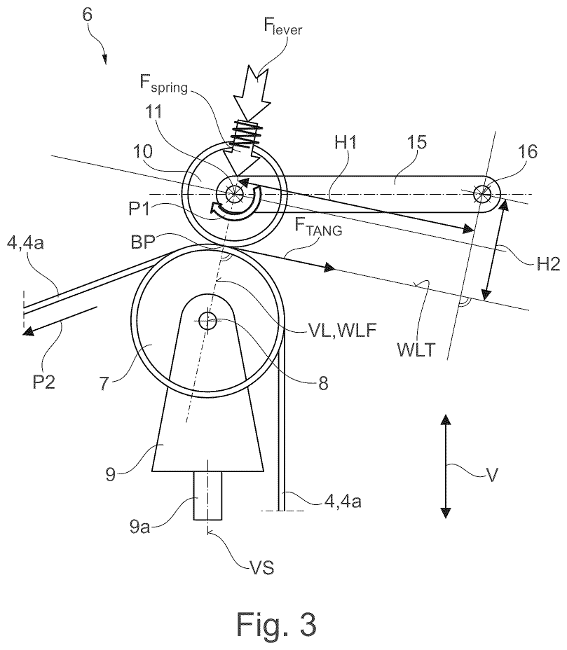

As can be seen in greater detail in connection with FIGS. 2 and 3, the ejector roller 7 can rotate around the axis of rotation 8 and is located in a bracket 9. In the illustrated embodiment, the bracket 9 is provided with a journal 9a, which can rotate around a vertical pivoting axis VS.

The pressure roller 10 is mounted on a cantilever arm 15 so that it can rotate around the pressure roller axis of rotation 11. The cantilever arm 15 is mounted on the bracket 9 so that it can rotate around a cantilever arm axis of rotation 16.

The axis of rotation 8 of the ejector roller 7, the pressure roller axis of rotation 11 of the pressure roller 10 and the cantilever arm axis of rotation 16 of the cantilever arm 15 are preferably parallel to one another and each in the form of a horizontal axis.

FIG. 3 shows the ejector arrangement according to FIG. 2, wherein the forces that occur during operation are indicated.

FIG. 3 illustrates the operational status of rope ejection, wherein the pressure roller 10 is driven by the drive motor 12 in the direction indicated by arrow P1 in the clockwise direction into a rope ejector direction, and the synthetic rope 4a is unspooled by the rope drum 3 and ejected in the direction indicated the arrow P2 on the ejector 6.

The pressure roller 11, by means of a pressure (pressing) force F_{spring}, presses the synthetic rope 4a guided by means of the ejector roller 7 onto the ejector roller 7. For the generation of the pressure force F_{spring}—as illustrated in FIG. 1-a spring device 30 comprising at least one tension spring 30a is provided.

A tangential force F_{tang} occurs between the pressure roller 10 driven by the drive motor 12 in the direction indicated by the arrow P1 in the clockwise direction in a rope ejection direction and the synthetic rope 4a. The tangential force F_{tang} is engaged at a point of contact BP at which the pressure roller 10 is in contact with the synthetic rope 4a. The contact point BP lies on a connecting line VL connecting the axis of rotation 8 of the ejector roller 7 with the pressure roller axis of rotation 11 of the pressure roller 10. The tangential force F_{tang} has a line of application WLT which at the contact point BP is perpendicular to the connecting line VL. The tangential force F_{tang} has a forced direction pointing to the side of the cantilever arm axis of rotation 16.

The line of application WLF of the pressure force F_{spring} corresponds to the connecting line VL.

In the ejector arrangement according to the invention, the cantilever arm axis of rotation 16 of the cantilever arm 15 is located in the vertical direction V over and therefore above the line of application WLT of the tangential force F_{tang}.

As shown in FIG. 3, the line of application WLF of the pressure force F_{spring} is separated from the cantilever arm axis of rotation 16 by a first lever arm H1. The line of application WLT of the tangential force F_{tang} is separated from the cantilever arm axis of rotation 16 by a second lever arm H2. The first lever arm H1 is the perpendicular distance of the line of application WLF from the cantilever arm axis of rotation 16. The second lever arm H2 is the perpendicular distance of the line of application WLT from the cantilever arm axis of rotation 16.

As a result of the position of the cantilever arm axis of rotation 16 of the cantilever arm 15 in the vertical direction V over and therefore above the line of application WLT of the tangential force F_{tang}, the tangential force F_{tang}, with the second lever arm H2 generates a torque around the cantilever arm axis of rotation 16, which corresponds to the force Fₗₑᵥₑᵣ with the lever arm H1 lying in the line of application WLF. The tangential force F_{tang} lying in the line of application WLT therefore generates the force Fₗₑᵥₑᵣ lying in the line of application WLF, which reinforces the pressure force F_{spring}.

As a result of the position of the cantilever arm axis of rotation 16 of the cantilever arm 15 in the vertical direction V over and therefore above the line of application WLT of the tangential force F_{tang}, the tangential force F_{tang} achieves a self-reinforcement of the pressing action of the pressure roller 10.

The ratio H2/H1 of the second lever arm H2 to the first lever arm H1 is in the range of 0.4 to is 1.8, in particular in the range of 0.6 to 1.2, preferably in particular in the range from 0.8 to 1.1.

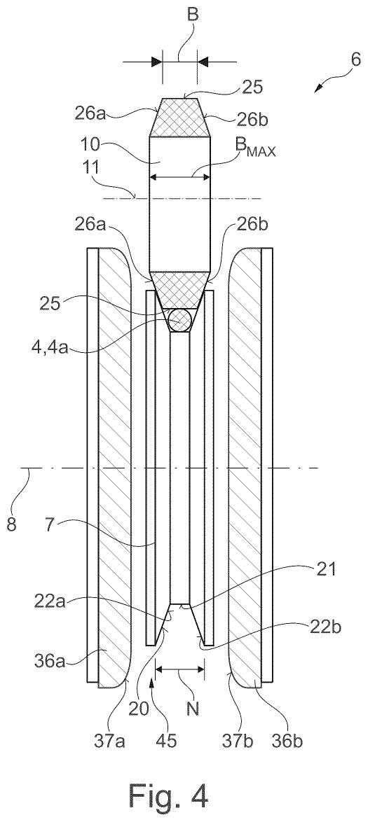

As illustrated in FIG. 4, which is a front elevation of FIG. 2 in the direction of arrow Y, the ejector roller 7 has a locator groove 20 in which the synthetic rope 4a is located. The locator groove 20 has a flat or domed groove base 21 on which the synthetic rope 4a lies, and two inclined lateral groove flanks 22a, 22b. The pressure roller 10 driven by the drive motor 12 protrudes into the locator groove 20 of the ejector roller 7 and is designed so that the synthetic rope 4a lying on the groove base 21 is pressed by an outside circumferential surface 25 of the pressure roller 10 against the groove base 21, and two lateral and inclined end surfaces 26a, 26b of the pressure roller 10 are in contact with the groove flanks 22a, 22b of the ejector roller 7 for the drive of the ejector roller 7 by the pressure roller 10. In the illustrated exemplary embodiment, between the pressure roller 10 and the ejector roller 7, there is a transmission of force between the inclined end surfaces 26a, 26b of the pressure roller 10 and the groove flanks 22a, 22b of the ejector roller 7 for a rotational coupling between the pressure roller 10 driven by the drive motor 12 and the ejector roller 7, so that the ejector roller 7 is driven by the pressure roller 10 driven by means of the drive motor 12.

The outside circumferential surface 25 with which the pressure roller 10 is in contact with the synthetic rope 4a is a rubberized outside circumferential surface.

The end surfaces 26a, 26b with which the pressure roller 10 is in contact against the groove flanks 22a, 22b of the ejector roller 7 are rubberized end surfaces.

By the pressure force F_{spring} generated by the spring device 30 and the force Fₗₑᵥₑᵣ originating from the tangential force F_{tang}, the pressure roller 10 is therefore biased toward the ejector roller 7 and is pressed into the locator groove 20 of the ejector roller 7 so that the pressure roller 10 is in contact via the rubberized outside circumferential surface 25 with the synthetic rope 4a and the synthetic rope 4a is pressed by the rubberized outside circumferential surface 25 onto the groove base 21 of the locator groove 20 of the ejector roller 7, and the rubberized end faces 26a, 26b of the pressure roller 10 come into contact with the groove flanks 22a, 22b of the ejector roller 7 and are in contact with the groove flanks 22a, 22b of the ejector roller 7.

To be able to transmit sufficient axial forces from the pressure roller 10 driven by the drive motor 12 to the synthetic rope 4 and to achieve a transmission of force by the pressure roller 10 driven by the drive motor 12 for the drive and rotation of the ejector roller 7, the external circumferential surface 25 that protrudes into the locator groove 20 and at least the areas of the two end faces 26a, 26b of the pressure roller 10 that protrude into the locator groove 20 are provided with a rubberized surface.

The shape of the locator groove 20 of the ejector roller 7 and the shape of the rubberized outside circumferential surface 25 and of the rubberized end surfaces 26a, 26b of the pressure roller 10 are thereby such that the flattening of the synthetic rope 4 under a tensile load is taken into consideration, so that a force ejecting the synthetic rope 4a can be applied by the driven pressure roller 10 by means of the outside circumferential surface 25, and between the end surfaces 26a, 26b and the groove flanks 22a, 22b of the locator groove 20 an entrainment in the form of a flank entrainment and a flank drive is achieved, with which the ejector roller 7 is rotated and driven by the driven pressure roller 10.

For this purpose, the pressure roller 10 is preferably formed by a steel roller onto which a rubber layer is vulcanized on the two end surfaces 26a, 26b and the outside circumferential surface 25.

The Shore A hardness of the rubberized outside circumferential surface 25 and the Shore A hardness of the rubberized end faces 26a, 26b is respectively in the range of 40 to 80, in particular in the range of 55 to 75.

The spring device 30 provided for the generation of the pressure force F_{spring}, which comprises at least one tension spring 30a, is biased so that a pressing force F_{spring} is generated on the synthetic rope 4a in the range between 50 N and 500 N, in particular in the range between 60 N and 400 N, preferably in particular between 70 N and 300 N. According to one advantageous configuration of the invention, the spring rate of the spring device is in the range between 3 N/mm and 10 N/mm, preferably in the range between 4 N/mm and 8 N/mm, particularly preferably in the range between 5 N/mm and 7 N/mm.

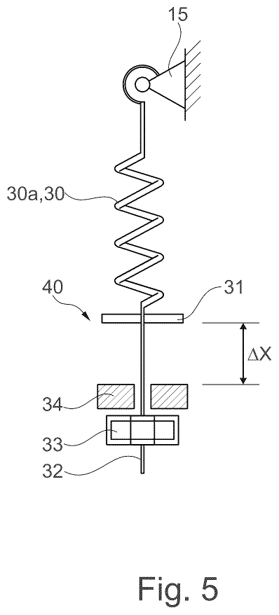

FIG. 5 illustrates a limiting device 40 with which the spring travel of the spring device 30 can be limited.

The spring device 30 in the form of a tension spring 30a is connected via a first end of the spring with the cantilever arm 15 at some distance from its cantilever arm axis of rotation 16. Via a second end of the spring, the tension spring 30a is connected with a screw head 31 of a regulating screw 32. The regulating screw 32 is connected by means of a regulating washer 33 with an abutment 34 which is located on or fastened to the bracket 9 of the ejector roller 7. The screw head 31 can be in contact against the abutment 34, as a result of which the spring travel of the spring device 30 is limited to the dimension AX illustrated in FIG. 5.

The cantilever arm axis of rotation 16 is preferably in the form of a horizontal journal located on the bracket 9, on which the cantilever arm 15 is rotationally mounted by means of a sleeve. The cantilever arm axis of rotation 16 preferably has some play around the vertical axis V. For this purpose the inside diameter of the sleeve can be slightly larger than the outside diameter of the horizontal journal.

The rubberized outside circumferential surface 25 of the pressure roller 11—as illustrated in FIG. 4—has a width B. The width B is preferably in the range of a factor of 0.5 to a factor of 2.5 of the inside rope diameter of the synthetic rope 4a.

FIG. 4 further shows a groove opening width N of the locator groove 20 of the ejector roller 7, and a maximum width Bₘₐₓ of the rubberized outside circumferential surface 25. The maximum width Bₘₐₓ of the rubberized outside circumferential surface 25 is the width dimension of the rubberized outside circumferential surface 25 in the radially inside terminal areas of the two rubberized end faces 26a, 26b.

The ratio of a groove opening width N of the locator groove 20 of the ejector roller 7 to the maximum width Bₘₐₓ of the rubberized outside circumferential surface 25 of the pressure roller 10 is in the range between 0.6 and 2.0, in particular in the range between 0.7 and 1.5.

FIG. 2 also shows the contact point BP which corresponds to the force application point of the tangential force F_{tang}, and an ejection point AS of the synthetic rope 4a at which the synthetic rope 4a lifts up from the ejector roller 7 as the rope is being ejected. The driven pressure roller 10 is located on the ejector roller 7 so that between the force application point (contact point BP) of the tangential force F_{tang} and the ejection point AS of the synthetic rope 4a from the ejector roller 7 there is an angle α between 0° and 40°, in particular between 10° and 35°, preferably in particular between 15° and 30°. The angle α is measured as the angle of rotation around the axis of rotation 8 of the ejector roller 7.

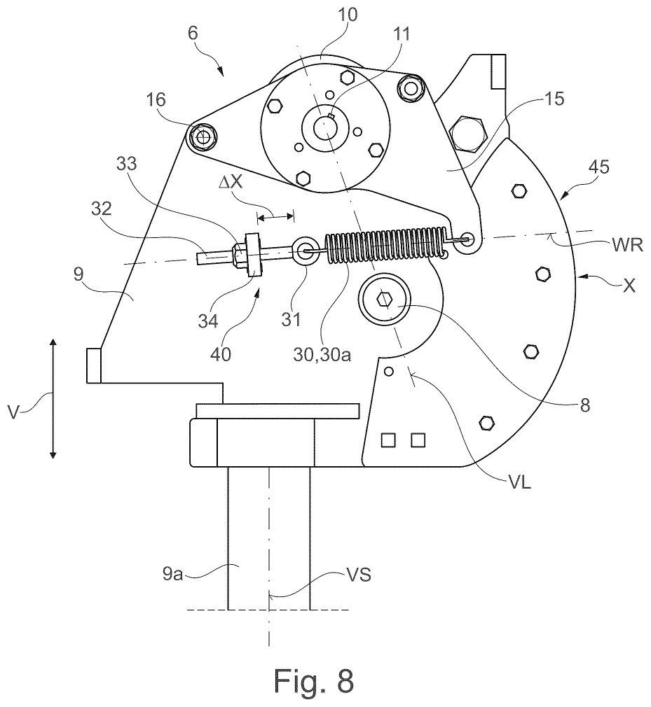

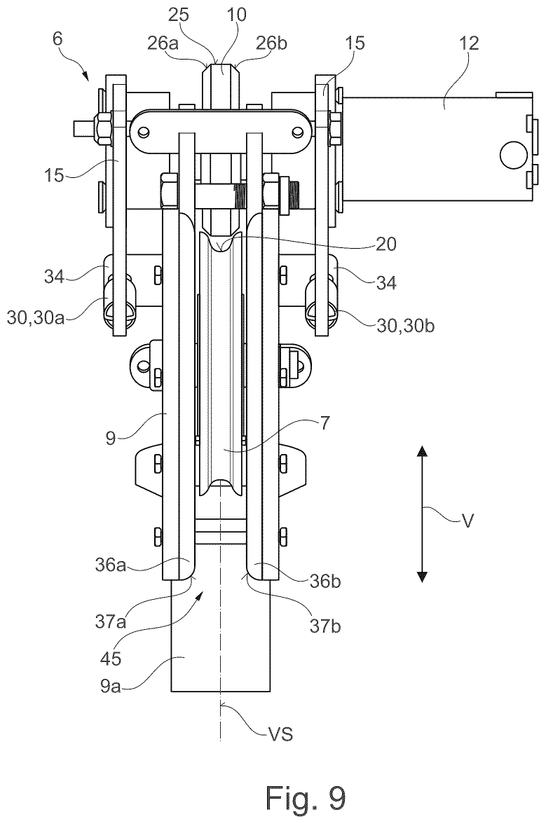

FIGS. 8 and 9 illustrate a constructive embodiment of the ejector arrangement according to the invention, wherein components that are identical to those illustrated in FIGS. 1 to 7 are identified by the same reference numbers. FIGS. 8 and 9 illustrate in greater detail the configuration of the cantilever arm 15, which is located so that can it can rotate around the cantilever arm axis of rotation 16 on the bracket 9. The journal 9a of the bracket 9 is also illustrated in greater detail. The embodiment of the spring device 30 with two tension springs 30a, 30b on opposite sides of the ejector roller 7 is also illustrated in greater detail. FIGS. 8 and 9 also show the coupling of the spring device 30 in the form of tension springs 30a to the cantilever arm 15 at some distance from its cantilever arm axis of rotation 16, and to the screw head 31 of the regulating screw 32, as well as the regulating nut 33 and the abutment 34 located on the bracket 9, against which the screw head 31 can come into contact.

FIGS. 8 and 9 also show a rope ejector opening 45 for the synthetic rope 4a, which is delimited laterally by two side plates 36a, 36b, between which the ejector roller 7 is located so that it can rotate and the synthetic rope 4 is guided. The side plates 36a, 36b are fastened to the bracket 9.

The two side plates 36a, 36b are made of a non-metallic material, in particular a synthetic material such as Duroplast, for example, and each have a rounded inside edge 37a, 37b, which form corresponding rounded rope runouts. With the rounded inside edges 37a, 37b, smooth rounded edges on the outer edges of the inner lateral flanks of the two side plates 36a, 36b are achieved, which represent the surfaces that come in contact with the synthetic rope 4a when the synthetic rope 4a is pulled slightly laterally out of the ejector head 7. When the synthetic rope 4a is pulled slightly laterally out of the rope ejector opening 35 of the ejector head 45, sharp edges that might result in damage to the synthetic rope 4a are eliminated.

FIG. 8 also shows in detail the arrangement of the tension springs 30a, 30b.

The tension springs 30a, 30b are arranged so that the tension springs 30a, 30b each have a direction of action WR which is essentially perpendicular to the connecting line VL connecting the axis of rotation 8 of the ejector roller 7 with the pressure roller axis of rotation 11 of the pressure roller 10. Within the meaning of the invention, essentially perpendicular means an angular range between 70° and 110°.

With an orientation of this type of the direction of action WR of the tension springs 30a, 30b, advantages are achieved if the synthetic rope 4a, on the end of the rope with twice the diameter, gets between the ejector roller 7 and the pressure roller 10, because as a result of the change of thickness of the synthetic rope 4a on the end of the rope and a resulting movement of the cantilever arm 15, there is only a slight change in the force of the tension springs 30a, 30b.

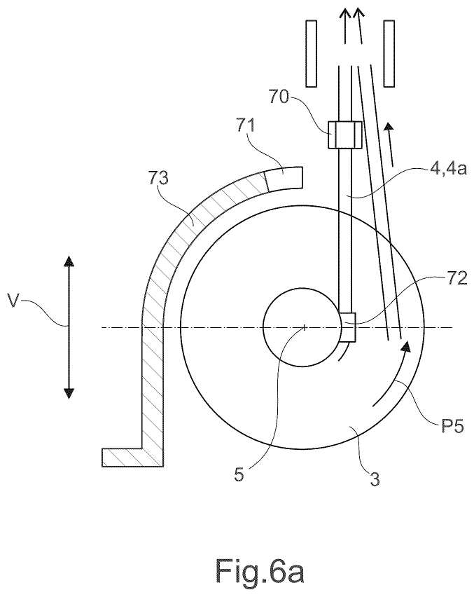

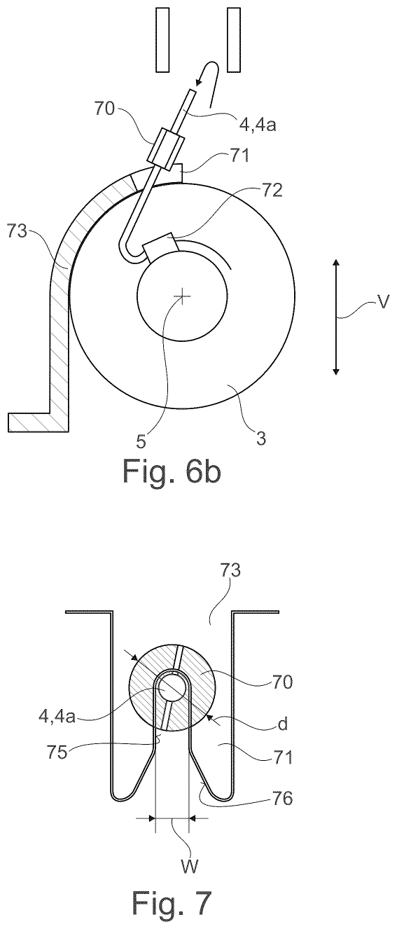

The rope drum 3 of a forestry winch 1 according to the invention is illustrated in further detail in FIGS. 6a, 6b and 7.

A rope stopper 70 is located on the synthetic rope 4a at some distance from the rope end of the synthetic rope 4a fastened to the rope drum 3. A rope stopper catch 71 is located in the vicinity of the rope drum 3, and is configured to interact with the rope stopper 70. The synthetic rope 4a is fastened to the rope drum 3 on the rope end with a fastening device 72. In the illustrated exemplary embodiment the rope stopper catch 71 is located on a bracket 73 which is located in the vertical direction V above the rope drum 3 between the rope drum 3 and the ejector 6.

The rope stopper 70 is preferably in the form of a ferrule or clamp component or screw component fastened to the synthetic rope 4a.

The rope stopper catch 71—as shown in FIG. 7—has a locator groove 75 with a V-shaped beveled locator 76 into which the synthetic rope 4a and the rope stopper 70 can be inserted.

In a contact position, the rope stopper 70 located on the synthetic rope 4a—as shown in FIG. 6b—is in contact on a lower end side with an upper side of the rope stopper catch 71. For this purpose, the diameter d of the rope stopper 70 is larger than the groove width W of the locator groove 75.

With the rope stopper 70 and the rope stopper catch 71, during the ejection of the synthetic rope 4a, an over-rotation of the rope drum 3 when it reaches the end of the synthetic rope 4a can be prevented.

If, as illustrated in FIG. 6a, during the ejection of the rope, the rope drum 3 is rotated in the unspooling direction illustrated by the arrow P5, the rope drum 3 is in the rotational position illustrated in FIG. 6a when the rope reaches its end. Because the synthetic rope 4a, on account of its high flexibility and pliancy, offers no resistance to the continued rotation of the rope drum 3, the rope drum 3—as illustrated in FIG. 6b—continues to rotate in the unspooling direction illustrated by the arrow P5. In that case, the synthetic rope 4a with the rope stopper 70, gets into the locator groove 75 of the rope stopper catch 71, wherein the rope stopper 70 comes into contact with the lower end of his face on the upper face of the rope stopper catch 71, as illustrated in FIG. 6b. The V-shaped beveled locator 76 hereby ensures the threading of the rope stopper 70 into the locator groove 75. In the contact position illustrated in FIG. 6b, the rotational movement of the rope drum 3 in the direction of rotation indicated by arrow P5 and an over rotation of the rope drum 3 are prevented.

1. An arrangement comprising an ejector and a rope for a forestry winch, wherein the ejector has a rotational ejector roller over which the rope is guided and deflected, and has at least one driven rotational pressure roller driven by a drive motor, wherein the pressure roller, by a pressure force, presses the rope guided over the ejector roller onto the ejector roller, and a tangential force occurs between the driven pressure roller and the rope, wherein the pressure roller is located on a cantilever arm so that the pressure roller can rotate around a pressure roller axis of rotation, wherein the cantilever arm is mounted so that it can rotate around a cantilever arm axis of rotation, and wherein the cantilever arm axis of rotation is located in the vertical direction above a line of application of the tangential force.

2. The arrangement according to claim 1, wherein the pressure roller has a rubberized outside circumferential surface by which the pressure roller is in contact with the rope, and wherein the Shore A hardness of the rubberized outside circumferential surface is in the range of 40 to 80.

3. The arrangement according to claim 1, wherein a line of application of the pressure force is separated from the cantilever arm axis of rotation by a first lever arm and the line of application of the tangential force is separated from the cantilever arm axis of rotation by a second lever arm, and wherein the ratio of the second lever arm to the first lever arm is in the range of 0.4 to 1.8.

4. The arrangement according to claim 1, wherein the driven pressure roller and the ejector roller are rotationally coupled, and between the driven pressure roller and the ejector roller an entrainment is provided to drive the ejector roller by the pressure roller, wherein the pressure roller has at least one rubberized end face by which the pressure roller is in contact with the ejector roller, and wherein the Shore A hardness of the rubberized end face is in the range of 40 to 80.

5. The arrangement according to claim 1, wherein for the generation of the pressure force, a spring device comprising at least one tension spring is provided, and wherein the spring device is biased so that a pressure force in the range between 50 N and 500 N is generated on the rope.

6. The arrangement according to claim 5, wherein the spring rate of the spring device is in the range between 3 N/mm and 10 N/mm.

7. The arrangement according to claim 5, wherein a limiting device is provided that limits the spring travel of the spring device.

8. The arrangement according to claim 7, wherein the spring device is fastened to a regulating screw, wherein the regulating screw is in connection by a regulating nut with an abutment, and the regulating screw is provided with a screw head, and wherein the screw head interacts with the abutment to limit the spring travel of the spring device.

9. The arrangement according to claim 4, wherein the ejector roller has a locator groove for the rope, wherein the locator groove has a flat or domed groove base on which the rope lies, and two lateral groove flanks, and wherein the pressure roller protrudes into the locator groove of the ejector roller and the pressure roller is designed so that the pressure roller protrudes into the locator groove, and so that the rope is pressed by the rubberized outside circumferential surface of the pressure roller against the groove base, and/or so that the rubberized end surfaces of the pressure roller are in contact with the groove flanks of the ejector roller.

10. The arrangement according to claim 1, wherein the cantilever arm axis of rotation has some play around a vertical axis.

11. The arrangement according to claim 2, wherein the rubberized outside circumferential surface of the pressure roller has a width in the range of a factor of 0.5 to a factor of 2.5 of the rope diameter.

12. The arrangement according to claim 9, wherein the ratio of a groove opening width of the locator groove of the ejector roller to a maximum width of the rubberized outside circumferential surface of the pressure roller is in the range between 0.6 and 2.0.

13. The arrangement according to claim 1, wherein the driven pressure roller is located on the ejector roller so that between a force application point of the tangential force and an ejection point of the rope from the ejector roller, there is an angle α between 0° and 40.

14. The arrangement according to claim 1, wherein the ejector has a rope ejector opening for the rope, which is delimited laterally by two side plates between which the rope is guided, and wherein the side plates have rounded inside edges as curved rope runout edges and the side plates are each made of non-metallic material.

15. A forestry winch which has a rope drum driven by a drive motor and an arrangement comprising an ejector and a rope, wherein the ejector has a rotational ejector roller over which the rope is guided and deflected, and has at least one driven rotational pressure roller driven by the drive motor, wherein the pressure roller, by a pressure force, presses the rope guided over the ejector roller onto the ejector roller, and a tangential force occurs between the driven pressure roller and the rope, wherein the pressure roller is located on a cantilever arm so that the pressure roller can rotate around a pressure roller axis of rotation, wherein the cantilever arm is mounted so that it can rotate around a cantilever arm axis of rotation, wherein the cantilever arm axis of rotation is located in the vertical direction above a line of application of the tangential force, and wherein the rope is guided from the rope drum to the ejector roller and over the ejector roller.

16. The forestry winch according to claim 15, wherein a rope stopper is located on the rope and a rope stopper catch is located in the vicinity of the rope drum and interacts with the rope stopper.

17. The forestry winch according to claim 16, wherein the rope stopper is in the form of one of a ferrule, a clamp component, and a screw component fastened to the rope.

18. The forestry winch according to claim 16, wherein the rope stopper catch has a V-shaped locator groove into which the rope stopper can be inserted.

19. The forestry winch according to claim 16, wherein in a contact position, the rope stopper located on the rope is in contact with a lower end face on an upper side of the rope stopper catch.

20. The arrangement according to claim 2, wherein the Shore A hardness of the rubberized outside circumferential surface is in the range of 55 to 75.

21. The arrangement according to claim 3, wherein the ratio of the second lever arm to the first lever arm is in the range of 0.6 to 1.2.

22. The arrangement according to claim 21, wherein the ratio of the second lever arm to the first lever arm is in the range of 0.8 to 1.1.

23. The arrangement according to claim 4, wherein the Shore A hardness of the rubberized end face is in the range of 55 to 75.

24. The arrangement according to claim 5, wherein the spring device is biased so that a pressure force in the range between 60 N and 400 N is generated on the rope.

25. The arrangement according to claim 24, wherein the spring device is biased so that a pressure force in the range between 70 N and 300 N is generated on the rope.

26. The arrangement according to claim 6, wherein the spring rate of the spring device is in the range between 4 N/mm and 8 N/mm.

27. The arrangement according to claim 26, wherein the spring rate of the spring device is in the range between 5 N/mm and 7 N/mm.

28. The arrangement according to claim 12, wherein the ratio of the groove opening width of the locator groove of the ejector roller to the maximum width of the rubberized outside circumferential surface of the pressure roller is in the range between 0.7 and 1.5.

29. The arrangement according to claim 13, wherein the angle α is between 10° and 35°.

30. The arrangement according to claim 29, wherein the angle α is between 15° and 30°.
